(19) United States
(12) Patent Application Publication
(10) Pub. No.: US 2023/0288348 A1
(43) Pub. Date: Sep. 14, 2023

(54) METHOD OF EVALUATING ANISOTROPY AND ANISOTROPY EVALUATION APPARATUS

(71) Applicants: RIGAKU CORPORATION, Tokyo (JP); TOYOTA JIDOSHA KABUSHIKI KAISHA, Toyota-shi (JP)

(72) Inventors: Masashi KAGEYAMA, Tokyo (JP); Kenichi OKAJIMA, Tokyo (JP); Masaru KURIBAYASHI, Tokyo (JP); Yuichi NAGAMATSU, Toyota-shi (JP); Yuzo MIURA, Toyota-shi (JP)

(73) Assignees: RIGAKU CORPORATION, Tokyo (JP); TOYOTA JIDOSHA KABUSHIKI KAISHA, Toyota-shi (JP)

(21) Appl. No.: 18/114,280

(22) Filed: Feb. 27, 2023

(30) Foreign Application Priority Data
Mar. 8, 2022 (JP) 2022-035373

(51) Int. Cl. G01N 23/041

(52) U.S. Cl. CPC G01N 23/041; G01N 2223/623; G01N 2223/615; G01N 2223/054

(57) ABSTRACT

There is provided a technique capable of evaluating an anisotropy of an object with a large field of view, in a non-destructive manner and with high angular resolution. An object 1 is irradiated with X-rays from a radiation source 22 of a phase-contrast X-ray optical system 2. A change characteristic in X-ray scattering intensities for individual relative angles each formed between an incident angle of the X-rays and an anisotropic structure in the object 1 are then acquired. Evaluation data for evaluating a state of the anisotropic structure in the object 1 is then generated based on the change characteristic in the X-ray scattering intensities.

### CROSS-REFERENCE TO RELATED APPLICATION

This patent application is based on and claims priority pursuant to Japanese Patent Application No. 2022-035373, filed on Mar. 8, 2022, in the Japan Patent Office, the entire disclosure of which is hereby incorporated by reference herein.

### BACKGROUND OF THE INVENTION

### Field of the Invention

The present invention relates to a technique for non-destructively evaluating an anisotropy of an object.

### Description of the Related Art

In recent years, CFRP (Carbon Fiber Reinforced Plastics) has been employed for a structural material for airplanes, wind power generators, EVs (Electric Vehicles), etc., in order to achieve both lightness and rigidity.

It is known that strength of CFRP varies greatly due to a slight deviation in fiber orientation. Therefore, it is desirable to strictly set the fiber orientation.

However, it is generally difficult to non-destructively determine the orientation of fibers in CFRP after resin molding.

Therefore, Japanese Patent Laid-Open No. 2017-3409 proposes a technique for non-destructively measuring the orientation of fibers constituting CFRP with a pulse laser. Further, Japanese Patent Laid-Open No. 2015-75428 proposes a technique for measuring physical properties of CFRP with electromagnetic induction heating. Unfortunately, these techniques involve low angular resolution for anisotropy in CFRP.

In contrast, the following non-patent literature proposes a method using X-ray phase-contrast method as a technique for non-destructively measuring the orientation of anisotropic materials such as fibers: M. Kageyama, et al., NDT and E International 105 (2019) 19-24. Although this technique can obtain a large field of view, it has a problem of low angular resolution.

Techniques for accurately measuring the three-dimensional orientation of an anisotropic material include a technique using X-ray CT, as described in Japanese Patent Laid-Open No. 2018-91765 and the following non-patent literature 2: Y. Sharma, et al., Appl. Phys. Lett. 109, 134102 (2016). However, in the case of the technique using CT, it is necessary to keep an entire object within the field of view. Therefore, it is difficult for these techniques to measure the structure of a large object.

The present invention has been made in view of the situation described above. An objective of the present invention is to provide a technique capable of evaluating anisotropy of an object with high angular resolution and in a non-destructive manner. Another objective of the present invention is to provide a technique capable of evaluating anisotropy with high angular resolution even for large-sized objects.

### SUMMARY OF THE INVENTION

The present invention can be expressed as an invention described in the following items.

(Item 1)

A method of evaluating anisotropy of an object with a phase-contrast X-ray optical system for detecting scattering of X-rays due to the object,
the object having an anisotropic structure oriented in at least one direction, the method including:
a step of irradiating the object with the X-rays from a radiation source of the phase-contrast X-ray optical system;
a step of acquiring a change characteristic in X-ray scattering intensities for individual relative angles each formed between an incident angle of the X-rays and the anisotropic structure in the object; and
a step of generating evaluation data for evaluating a state of the anisotropic structure in the object based on the change characteristic in the X-ray scattering intensities.

(Item 2)

The method of evaluating anisotropy according to Item 1, wherein
the change characteristic is any one of a peak intensity obtained through fitting of a change in the X-ray scattering intensities with a predetermined function, a peak angle that is the relative angle at the peak intensity, and a peak width.

(Item 3)

The method of evaluating anisotropy according to Item 1, wherein
the change characteristic is any one of a peak intensity obtained through fitting of a change in the X-ray scattering intensities with a predetermined function, a peak angle that is the relative angle at the peak intensity, and a peak width, and
the evaluation data is an image in which: one of the peak intensity, the peak angle, and the peak width is represented by one of brightness and color; and another one is represented by another of brightness and color.

(Item 4)

The method of evaluating anisotropy according to any one of Items 1 to 3, wherein
the step of acquiring the change characteristic in the X-ray scattering intensities for individual relative angles each formed between an incident angle of the X-rays and the anisotropic structure in the object is performed while at least one grating that constitutes the phase-contrast X-ray optical system is moved in a periodic direction.

(Item 5)

An anisotropy evaluation apparatus, including:
a phase-contrast X-ray optical system configured to detect scattering of X-rays due to an object;
an angle changing unit configured to change a relative angle between the object and the X-rays; and
a processing unit, wherein
the phase-contrast X-ray optical system includes:
   a grating unit;
   a radiation source configured to irradiate the grating unit and the object with X-rays; and
   a detection unit configured to detect the X-rays that have passed through the grating unit and the object,
the object has an anisotropic structure oriented in at least one direction,
the angle changing unit is configured to change a relative angle between an incident angle of the X-rays and the anisotropic structure in the object, and
the processing unit includes:
   a characteristic acquisition unit configured to acquire a change characteristic in X-ray scattering intensities for individual relative angles each formed between the X-rays and the object, using intensity values of the X-rays detected by the detection unit; and
   a data generating unit configured to generate evaluation data for evaluating a state of the anisotropic structure in the object based on the change characteristic in the X-ray scattering intensities.

(Item 6)

The anisotropy evaluation apparatus according to Item 5, wherein
the angle changing unit is configured to rotate the object, and a rotation axis of the object is orthogonal to an incident direction of the X-rays.

(Item 7)

The anisotropy evaluation apparatus according to Item 5, wherein
an irradiation direction of the X-rays is radial, and
the angle changing unit is configured to change a relative angle between an incident angle of the X-rays and the object by linearly moving the object in a direction intersecting with the irradiation direction of the X-rays.

The present invention makes it possible to evaluate the anisotropy of an object with a large field of view, high angular resolution, and in a non-destructive manner.

### BRIEF DESCRIPTION OF THE DRAWINGS

FIG. 1 is a perspective view for explaining a schematic structure of an anisotropy evaluation apparatus according to a first embodiment of the present invention;

FIG. 2 is a block diagram for explaining a processing unit to be used in the apparatus of FIG. 1;

FIG. 3 is an explanatory diagram for explaining a procedure of a method of evaluating anisotropy according to the first embodiment of the present invention;

FIG. 4 is an explanatory diagram for explaining a graph showing a relationship between fiber angles (degrees) and scattering intensities (arbitrary unit), and how to take the fiber angles;

FIG. 5 is a graph showing a relationship between fiber angles (degrees) and scattering intensities (arbitrary unit);

FIG. 6(A) is an image of a distribution of peak intensities, FIG. 6(B) is an image of a distribution of peak angles, and FIG. 6(C) is an image of a distribution of peak widths;

FIG. 7 is a histogram with the peak widths (degrees) on a horizontal axis and the number of pixels on a vertical axis;

FIG. 8 is an explanatory diagram for explaining a procedure of a method of evaluating anisotropy according to a second embodiment of the present invention;

FIG. 9 is a graph showing change in X-ray intensities for each pixel in the second embodiment of the present invention, with a horizontal axis of frame numbers in a moving image (corresponding to rotation angles of an object) and a vertical axis of X-ray intensities (arbitrary unit);

FIG. 10(A) to 10(C) are explanatory diagrams showing examples of images obtained in the second embodiment of the present invention, and FIG. 10(A) is an image of a distribution of peak intensities, FIG. 10(B) is an image of a distribution of peak angles, and FIG. 10(C) is an image of a distribution of peak widths;

FIG. 11 is a perspective view for explaining a schematic structure of an anisotropy evaluation apparatus according to a third embodiment of the present invention;

FIG. 12 is a front view for explaining a schematic structure of the anisotropy evaluation apparatus according to the third embodiment of the present invention; and

FIG. 13 is an explanatory diagram for explaining a procedure of a method of evaluating anisotropy according to the third embodiment of the present invention.

### DETAILED DESCRIPTION OF THE PREFERRED EMBODIMENTS

### First Embodiment

An anisotropy evaluation apparatus according to a first embodiment of the present invention and a method of evaluating anisotropy using the same will be described below with reference to the drawings. First, as a base of the description, an object to be evaluated for anisotropy will be described.

(Object)

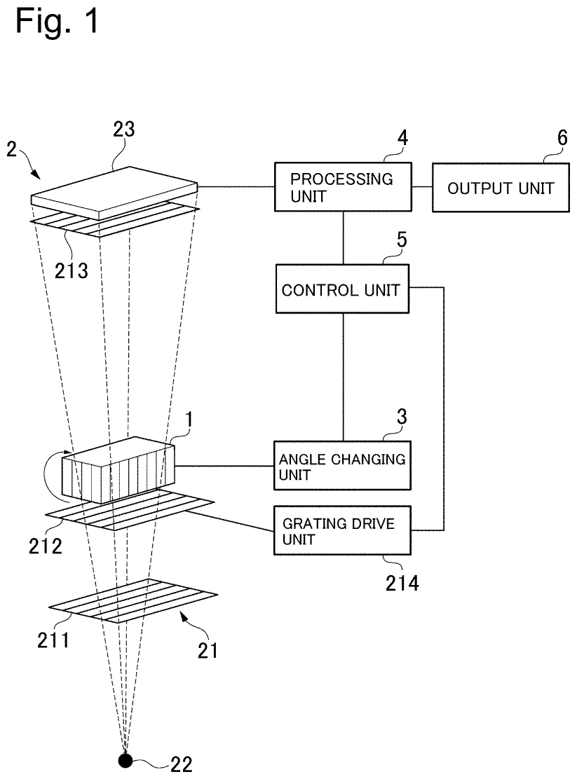

An object 1 of the present embodiment to be used is a UD (uni-directional) material, which has anisotropy in one direction (See FIG. 1). This object 1 has carbon fibers (not shown) arranged in one direction as an anisotropic material. In other words, the object 1 in the present embodiment has an anisotropic structure oriented in at least one direction.

(Anisotropy Evaluation Apparatus of the Present Embodiment)

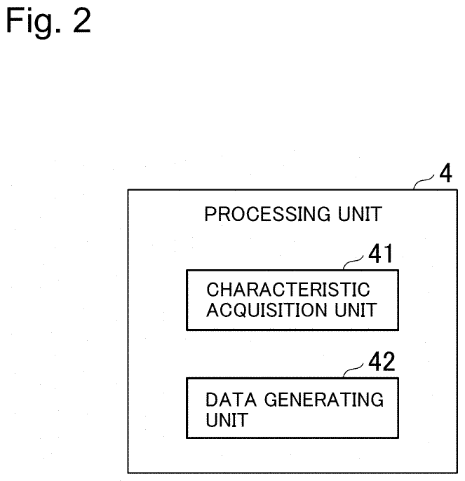

Next, an anisotropy evaluation apparatus according to the present embodiment will be described with reference to FIGS. 1 and 2.

The apparatus includes basic components including: a phase-contrast X-ray optical system 2 for detecting scattering of X-rays due to an object 1; an angle changing unit 3 for changing the relative angle between the object 1 and X-rays; and a processing unit 4. Furthermore, the apparatus includes additional components including a control unit 5 and an output unit 6 (see FIG.

(X-Ray Phase Optical System)

The phase-contrast X-ray optical system 2 has: a grating unit 21; a radiation source 22 for irradiating the grating unit 21 and the object 1 with X-rays; and a detection unit 23 for detecting the X-rays having passed through the grating unit 21 and the object 1, for each pixel.

The grating unit 21 includes a G0 grating 211, a G1 grating 212, and a G2 grating 213 for constituting a Talbot-Lau interferometer. Further, this grating unit 21 includes a grating drive unit 214 for driving the G1 grating 212 to perform what is called a fringe scanning method. The G0 grating 211 is an absorption grating through which X-rays from the radiation source 22 generating non-coherent X-rays penetrate to equivalently generate a plurality of coherent point light sources. In other words, the G0 grating 211 can be said to be substantially a part of the radiation source. The grating drive unit 214 can use an appropriate drive mechanism capable of driving the grating by predetermined steps at required timing, such as a ball screw, a linear motor, a piezo element, or an electrostatic actuator.

The radiation source 22 generates X-rays with required intensity and irradiates the grating unit 21 and the object 1 with the X-rays. The radiation source 22 to be used can be one that generates X-rays with low spatial coherence in the case of a Talbot-Lau interferometer configuration. In a case in which the G0 grating is omitted, the radiation source 22 to be used is a radiation source (for example, a minute point light source) that generates spatially coherent X-rays to the extent necessary for practical use (that is, that has high spatial coherence). In the present embodiment, it is preferable that the direction of X-rays from the radiation source 22 to the object 1 is roughly an extension direction of the anisotropic material included in the object 1 at any position within a range of rotating the object 1 with the angle changing unit 3. This point will be described below.

The detection unit 23 has a plurality of pixels (not shown) capable of providing practically sufficient resolution, and can acquire an intensity distribution image of X-rays that have passed through the grating unit 21 and the object 1, with these pixels. The intensity distribution image (that is, the X-ray intensities for individual pixels) acquired by the detection unit 23 is sent to the processing unit 4.

Since the phase-contrast X-ray optical system 2 used in the present embodiment may be basically the same as ones conventionally used, further detailed description is omitted. (reference: International Publication No. WO 2004/058070, Pfeiffer F, Weitkamp T, Bunk O, David C, Phase retrieval and differential phase-contrast imaging with low-brilliance X-ray sources. Nat. Phys.2 (2006) 258-261).

(Angle Changing Unit)

The angle changing unit 3 is configured to change the relative angle between an incident angle of X-rays and the anisotropic structure in the object 1. More specifically, the angle changing unit 3 in the present embodiment is configured to rotate the object 1 by an appropriate rotating mechanism (not shown). Here, the rotation axis of the object 1 (not shown) is a direction orthogonal to the incident direction of X-rays. Note that the rotation axis of the object 1 here means the center of rotation of the object 1, and may be a virtual one. Here, the rotating mechanism is, for example, a control motor controlled by the control unit 5, but is not limited to this.

(Processing Unit)

The processing unit 4 has: a characteristic acquisition unit 41 that acquires a change characteristic in X-ray scattering intensities for individual relative angles each formed between the X-rays and the object 1 for each pixel using the intensity values of the X-rays detected by the detection unit 23; and a data generating unit 42 that generates evaluation data for evaluating a state of the anisotropic structure in the object 1 based on the change characteristic in the X-ray scattering intensities (see FIG. 2). Detailed operation of the characteristic acquisition unit 41 and the data generating unit 42 will be described below. The processing unit 4 is specifically implemented by a combination of computer hardware and software.

(Control Unit)

The control unit 5 controls the drive amount (that is, movement amount or movement angle) and drive timing by each of the grating drive unit 214 and the angle changing unit 3. The control unit 5 is also implemented by a combination of computer hardware and software. The control unit 5 operates according to commands from the processing unit 4. The functions of the control unit 5 may be implemented in the processing unit 4 and the two may be integrated.

(Output Unit)

The output unit 6 outputs a result of processing of the processing unit 4 to a user or other equipment. The output unit 6 is, for example, a display or a printer, but may be an interface for connecting other equipment that receives the result of processing. Also, the output unit 6 may transmit the result of processing to other equipment via a network.

(Method of Evaluating Anisotropy in Present Embodiment)

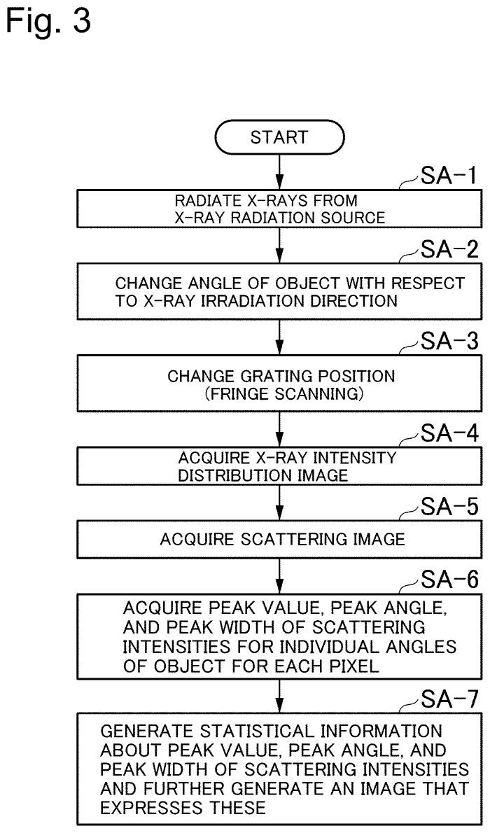

An example of a method of evaluating the anisotropy of the object 1 with the above-described apparatus will be described below with further reference to FIG. 3.

(Step SA-1 in FIG. 3)

First, as shown in FIG. 1, the object 1 is arranged between the radiation source 22 and the detection unit 23. Specifically, in the present embodiment, the object 1 is arranged between the G1 grating 212 and the G2 grating 213. However, the position of the object 1 is not limited to this, and may be any position between the G0 grating 211 and the G2 grating 213. Here, it is preferable that the object 1 be arranged so that the direction of X-rays, which are radiated by the radiation source 22 of the phase-contrast X-ray optical system 2, is in the extension direction of the anisotropic structure (for example, carbon fiber) in the object 1, at any position within the range of rotating the object 1 with the angle changing unit 3. In this state, X-rays are radiated from the radiation source 22 toward the detection unit 23. In practice, the extension direction of the anisotropic structure in the object 1 to be evaluated is roughly known in many cases.

(Step SA-2 in FIG. 3)

Step SA-2 may be executed in the first operation, or may be omitted. Here, the step will be explained as a step performed after step SA-5 to be described below. After a scattering image is acquired in step SA-5, the angle changing unit 3 changes the angle of the object 1 with respect to the X-ray irradiation direction. More specifically, the angle changing unit 3 changes the relative angle between the incident angle of X-rays and the anisotropic structure in the object 1. Thereafter, Step SA-3 and subsequent steps to be described below are performed.

(Step SA-3 to 4 in FIG. 3)

The X-rays radiated from the radiation source 22 toward the object 1 pass through the grating unit 21 and the object 1, and reaches the detection unit 23. More specifically, in the present embodiment, X-rays penetrate through the G0 grating 211, the G1 grating 212, the object 1, and the G2 grating 213 in this order, and reach the detection unit 23. The detection unit 23 acquires an intensity distribution image of the X-rays that have reached it (in other words, image signals each indicating the X-ray intensity for each pixel) (step SA-4). The acquired intensity distribution image is sent to the processing unit 4. Here, in the present embodiment, a usual fringe scanning method is performed. Specifically, the control unit 5 drives the grating drive unit 214 of the grating unit 21 to move the grid (G1 grid in this example) by appropriate steps (step SA-3). In other words, the intensity distribution image is acquired after the grating position change for the fringe scanning method. M (M≥3) intensity distribution images are acquired per grating period (in the example of the present embodiment, the grating period of the G1 grating). Steps SA-3 and SA-4 are repeated until the required number of images (for example, three) are acquired for performing the fringe scanning method.

(Step SA-5 in FIG. 3)

The characteristic acquisition unit 41 of the processing unit 4 acquires a scattering image using M (M≥3) intensity distribution images per period of the self-image of the grating. The scattering image described here is obtained through normalizing amount of decrease in the coherence (visibility) acquired through the phase-contrast X-ray imaging method and taking the logarithm thereof, and is the same as what is called the dark field image. Since the method itself of acquiring the scattering image by the fringe scanning method may be the same as the method conventionally known, detailed description thereof is omitted. Then, the process returns to step SA-2 and repeats the above procedure. If the object 1 has been rotated by the required angles and times, the process proceeds to step SA-6. In the present embodiment, the maximum rotation angular range of the object is ±20°, but it is not limited to this.

(Step SA-6 in FIG. 3)

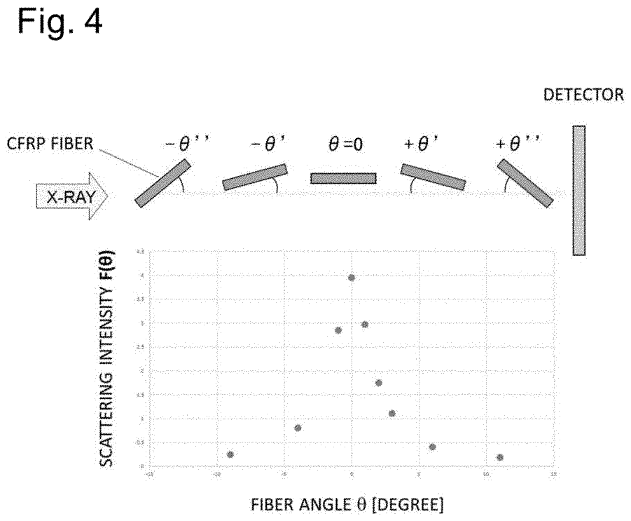

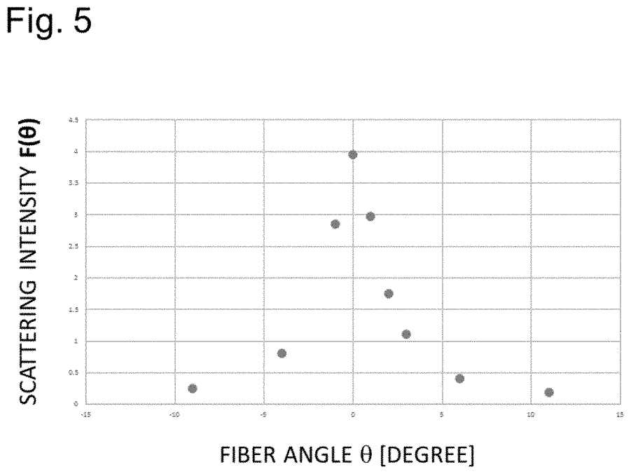

As a base of the following description, a relationship between an anisotropic structure (for example, a fiber) and X-rays scattering intensities will be described here. The scattering intensity described here is the luminance value of the scattering image described above, and is the same as the dark field signal intensity. FIG. 4 shows a relationship between fiber angles θ°, which are angles between an anisotropic structure (for example, a fiber) and X-rays, and scattering intensities F(θ), which indicate the intensities of scattering due to the object 1. As can be seen from this figure, the scattering intensity reaches a maximum when the fiber angle θ=0°, and decreases as the θ is away from 0° in the positive or the negative direction. Here, the characteristics shown in the lower part of FIG. 4 use measurement results shown in FIG. 5 to be described below.

In this step SA-6, the characteristic acquisition unit 41 of the processing unit 4 acquires the relationship between the fiber angles θ° and the scattering intensities F(θ) for each pixel, based on the obtained scattering images, as shown in FIG. 5. The direction of the fiber is assumed to be approximately known in this example. Therefore, the fiber angle can be estimated from the rotation angle of the object 1. However, even if the direction of the fibers is unknown, the object 1 just need to be rotated over the range including the peak value shown in FIG. 5. In a case in which the direction of the fiber is uncertain, it is normally preferable to expand the rotation angle of the object 1.

Next, for each pixel, the characteristic acquisition unit 41 acquires: a peak intensity obtained through fitting of change in X-ray scattering intensities (see FIG. 5) with a predetermined function; the peak angle, which is the fiber angle (that is, the angle of the anisotropic structure) at the peak intensity; and the peak width (half-width in this example). These peak intensity, peak angle and peak width each are an example of “a change characteristic in X-ray scattering intensities for individual relative angles each formed between an incident angle of X-rays and the anisotropic structure in the object 1” in the present invention. In the present embodiment, Lorenz function is used for fitting, but other appropriate functions can be used. Since the fitting manner itself may be the same as manners conventionally used, detailed description is omitted.

(Step SA-7 in FIG. 3)

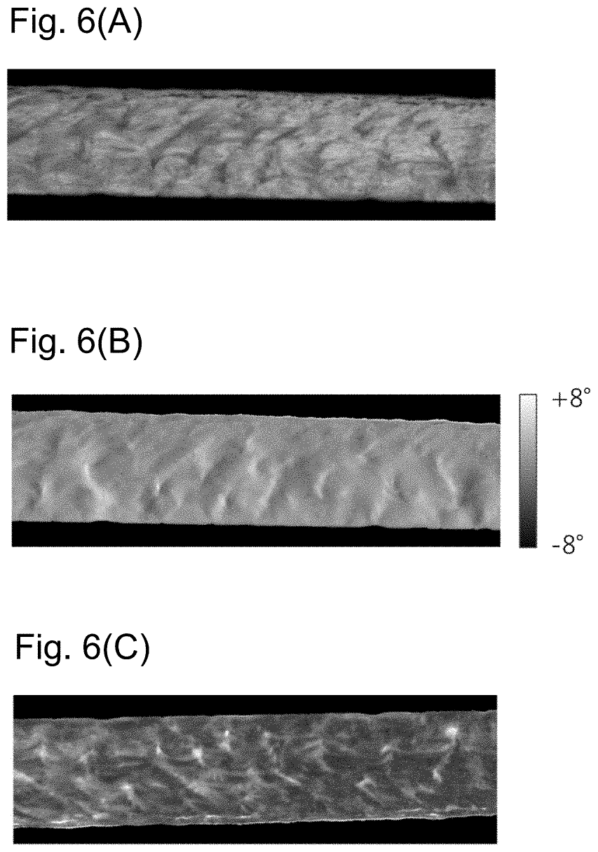

As shown in FIG. 6, the data generating unit 42 generates the peak intensities (FIG. 6(A)), the peak angles (FIG. 6(B)) and the peak widths (FIG. 6(C)) as contrast images. The images are sent from the processing unit 4 to the output unit 6 and can be seen by a user.

In the present embodiment, the images of the distributions of peak intensities, peak angles, and peak widths can be made and displayed. Therefore, the user can see this image to readily acquire information about the orientation of the anisotropic structure. Specifically, the amount of the fiber and the degree of orientation (variation in orientation) of the fiber can be estimated from the peak intensities, the direction of orientation of the fiber from the peak angles, and the degree of orientation (variation in orientation) of the fiber from the peak widths. However, it is not necessary to acquire all of these characteristics, and it may be possible to acquire one or two characteristics as necessary.

Further, in the above embodiment, the contrast images corresponding to peak widths and the like are acquired. However, alternatively or additionally, it is possible to generate an image (not shown) in which: one of the peak intensity, the peak angle, and the peak width (for example, the peak intensity) is represented by one of brightness and color; and another one of the peak intensity, the peak angle, and the peak width (for example, the peak angle) is represented by the other of brightness and the color. In this case, a plurality of pieces of information can be acquired from one image at the same time, resulting in an advantage that the user readily see or understand it.

In addition, since the present embodiment uses an intensity distribution image in a phase-contrast X-ray optical system, highly accurate estimation is possible.

Moreover, in the present embodiment, as shown in FIG. 5, a relationship between fiber angles θ° and scattering intensities F(θ) has very peaky (that is, acute) characteristics. Therefore, it is possible to exhibit high angular resolution (for example, angular resolution in units of 1°).

Furthermore, since CT is not used in the present embodiment, there is no need to bring the entire object into the field of view at once. This results in an advantage that anisotropy evaluation of a large object can be easily performed (that is, a substantial field of view can be expanded).

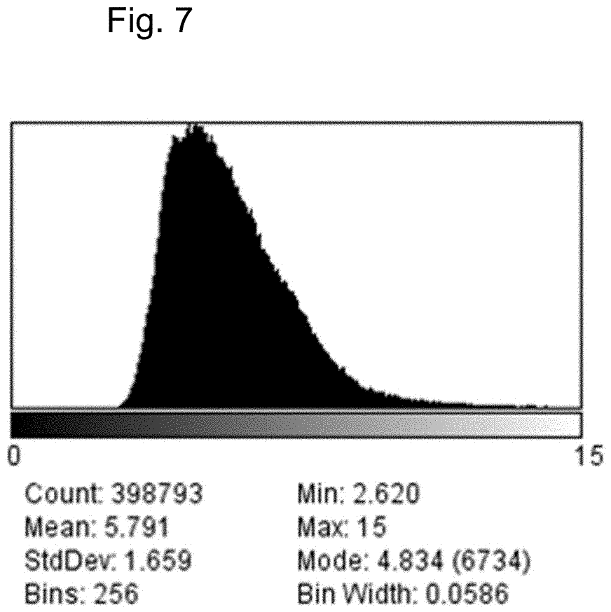

The data generating unit 42 of the present embodiment also generates a histogram of the peak widths (horizontal axis) and the corresponding numbers of pixels (vertical axis), as shown in FIG. 7. This histogram allows the user to obtain statistical information about the orientation variation in a plane.

The images in FIGS. 6(A) to 6(C) and the histogram in FIG. 7 each correspond to an example of “evaluation data for evaluating a state of the anisotropic structure in the object based on a change characteristic in X-ray scattering intensity” in the present invention.

### Second Embodiment

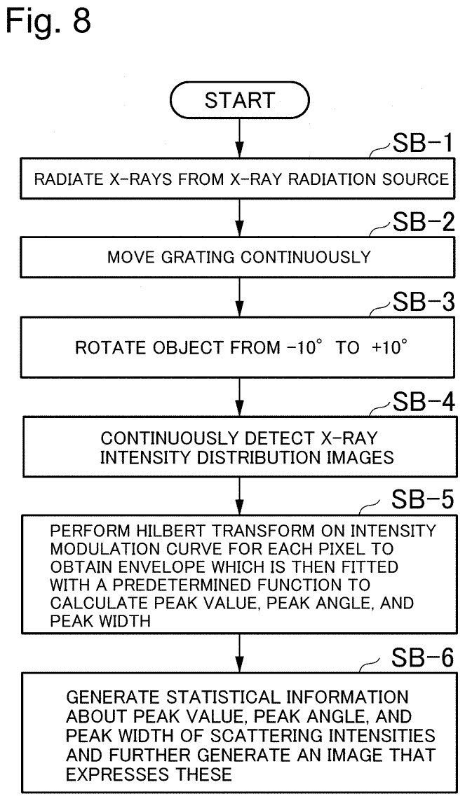

Next, an anisotropy evaluation apparatus and a method of evaluating anisotropy according to a second embodiment of the present invention will be described with reference to FIGS. 8 to 10. In description of the second embodiment, the same reference numerals are used for components that are basically common to those of the first embodiment described above to avoid complication of the description.

(Step SB-1 to SB-4 in FIG. 8)

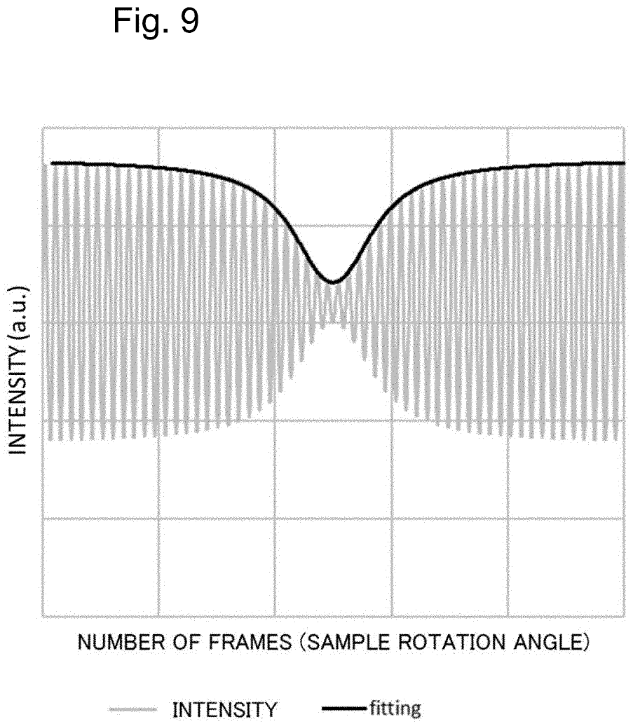

In the second embodiment, while the radiation source 22 irradiates the object 1 with X-rays, the grating drive unit 214 continuously moves one of the gratings (the G1 grating 212 in this example) in the periodic direction. In parallel with this, the angle changing unit 3 rotates the object 1 within a predetermined range (from −10° to +10° in this example). Then, the detection unit 23 continuously detects the X-ray intensities (that is, the image signals) for each pixel. FIG. 9 shows an example of X-ray intensity change obtained at a certain pixel. The movement of the grating causes the X-ray intensity to change sinusoidally. The intensity of this sinusoidal wave changes with the rotation of the object 1 (that is, with the change in the relative angle between the X-rays and the anisotropic structure). The envelope of sinusoidal wave then shows a relationship between the fiber angles and the scattering intensities, similarly to FIG. 5. Note that fringe scanning is not performed in the second embodiment.

(Step SB-5 in FIG. 8)

Then, the characteristic acquisition unit 41 of the present embodiment obtains an envelope through Hilbert transform on the sinusoidal intensity modulation curve (see FIG. 9) for each pixel. Furthermore, the characteristic acquisition unit 41 fits the envelope with a predetermined function, and calculates a peak value, a peak angle, and a peak width for each pixel. An example of this predetermined function is shown below.

exp(−(y0+A/((x−x0)\hat{ }2+B))),
where A/B is the peak intensity, x0 is the peak angle, and 2√B is the full width at half maximum of the peak. This corresponds to a Lorentzian exponential function.

(Step SB-6 in FIG. 8)

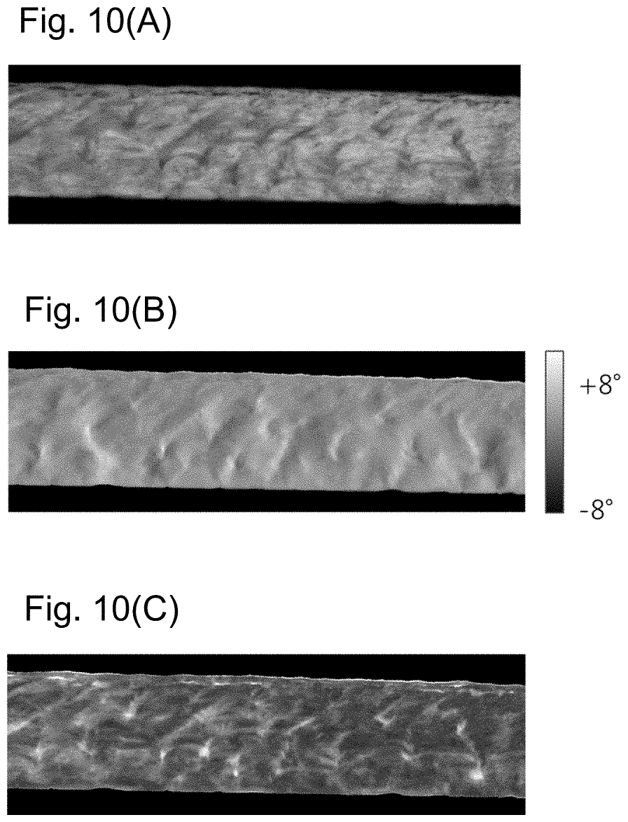

Next, the data generating unit 42 of the present embodiment make images of the distributions of peak intensities, peak angles and peak widths (see FIG. 10). Since this processing is the same as that of the first embodiment described above, detailed description thereof is omitted.

The method of evaluating anisotropy of the second embodiment does not require fringe scanning, so the method has an advantage that the time required for the anisotropy evaluation can be shortened. Here, the rotation of the object 1 changes the attenuation amount of X-rays, and this may cause the envelope of the intensity modulation curve to fluctuate. Although this may be noise, but the shape of the object 1 is known in many cases, so that it is possible to remove such noise by appropriate normalization processing.

Other configurations and advantages of the second embodiment are the same as those of the above-described first embodiment, so further detailed description is omitted.

### Third Embodiment

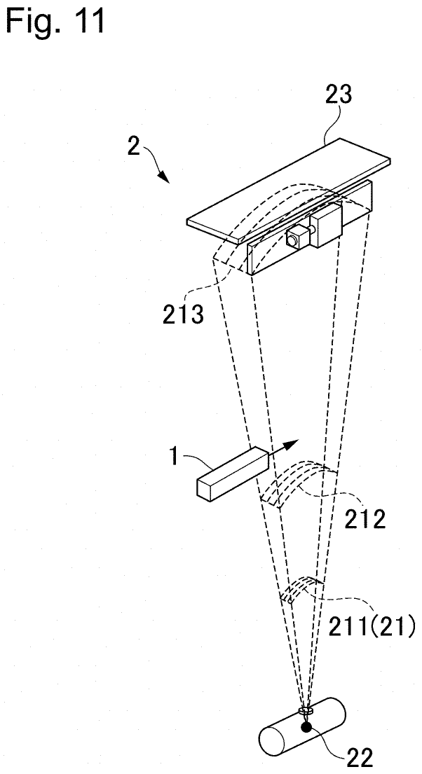

Next, an anisotropy evaluation apparatus and a method of evaluating anisotropy according to a third embodiment of the present invention will be described with reference to FIGS. 11 to 13. In description of the third embodiment, the same reference numerals are used for components that are basically common to those of the first embodiment described above to avoid complication of the description.

The irradiation direction of the X-rays from the radiation source 22 of the third embodiment is radial (what is called a fan beam) as shown in FIG. 11. The angle of the field of view in this example is, for example, about 10°, but is not limited to this.

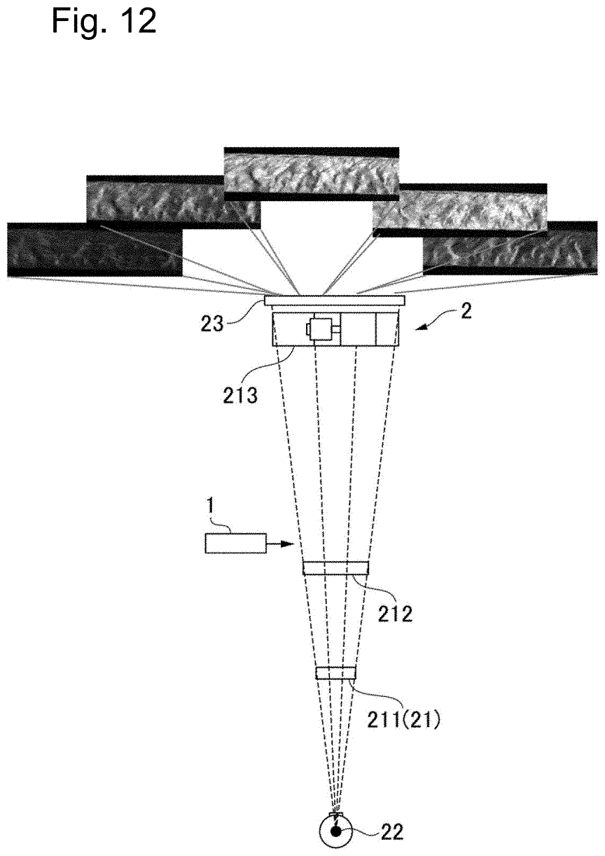

The angle changing unit 3 in the third embodiment linearly moves the object 1 in a direction intersecting with the irradiation direction of the X-rays (an arrow direction in FIG. 11). Thereby, the relative angle between the incident angle of X-rays and the object is changed. Note that each grating which constitutes the grating unit 21 is preferably curved as shown in FIG. 11, but each grating is drawn in flat form in FIG. 12 for easy understanding. In the present embodiment, the periodic direction of each grating configuring the grating unit 21 is parallel to the moving direction of the object 1.

The basic configuration of the phase-contrast X-ray optical system 2 in the third embodiment can be the same as that described in Japanese Patent No. 6422123 except for the above points, so further detailed description is omitted.

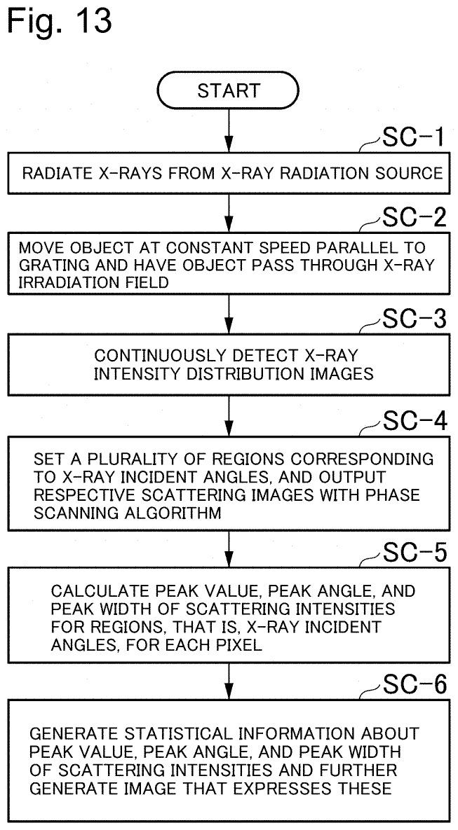

Next, the method of evaluating anisotropy in the third embodiment will be described with reference to FIG. 13.

(Steps SC-1 to 3 in FIG. 13)

First, the object 1 is irradiated with X-rays from the radiation source 22. In parallel with this, the angle changing unit 3 linearly moves the object 1 in a direction intersecting with the irradiation direction of the X-rays (see FIG. 12). Furthermore, the detection unit 23 continuously acquires the X-ray intensities (that is, the image signals) for each pixel.

(Step SC-4 in FIG. 13)

Next, the characteristic acquisition unit 41 of the third embodiment calculates a scattering image (that is, X-ray scattering intensity for each pixel) for each of a plurality of regions corresponding to the X-ray incident angle (see regions defined by dashed lines in FIG. 12) through a manner disclosed in Japanese Patent No. 6422123. Here, the regions correspond to the incident angles of X-rays in the first embodiment, and different regions mean different X-ray incident angles. Note that it is possible to divide the regions more finely.

(Step SC-5 to 6 in FIG. 13)

Next, for each pixel, the characteristic acquisition unit 41 of the present embodiment calculates the peak value, the peak angle, and the peak width of the scattering intensities for the individual regions, that is, the X-ray incident angles, in the same manner as in the first embodiment.

Next, the data generating unit 42 generates images as shown in FIG. 6, for example. FIG. 12 shows examples of images for individual regions (five regions in an example in FIG. 12).

The method of evaluating anisotropy of the third embodiment has an advantage that allows the object 1 to be imaged while being moved, resulting in easy anisotropy evaluation of a large-sized object.

Other configurations and advantages of the third embodiment are the same as those in the above-described first embodiment, so further detailed description is omitted.

Note that the description of each of the above embodiments is merely an example, and does not show the configuration essential to the present invention. The configuration of each unit is not limited to the above as long as the gist of the present invention can be achieved.

For example, the G0 grating can be omitted by using a structured target substantially equivalent to the G0 grating as the radiation source 22.

Alternatively, as the grating unit 21, a grating unit called edge illumination can be used to generate a scattering image without using the configuration of the Talbot-Lau interferometer (reference: A. Olivo, “Edge-illumination x-ray phase-contrast imaging”, J. Phys.: Condens. Matter 33(2021) 363002).

Furthermore, in the first and third embodiments described above, the G1 grating 212 is driven for the fringe scanning method, but instead of this, other gratings may be moved.

Alternatively, the object 1 may have anisotropy in a plurality of directions. In this case, a plurality of peaks as shown in FIG. 5 may be detected. However, the anisotropy in the individual direction can be evaluated by separating a plurality of peaks with appropriate fitting and applying the above method to each peak.

Furthermore, the angle changing unit 3 in each of the above-described embodiments rotates the object 1. However, rotation of the phase-contrast X-ray optical system 2 around the object 1 can change the relative angle between the object 1 and the X-rays. Moreover, the rotation axis of the object 1 may not be single. For example, the object 1 can rotate around rotation axes in a plurality of directions.

### REFERENCE SIGNS LIST

1 object
2 phase-contrast X-ray optical system
21 grating unit
211 G0 grating
212 G1 grating
213 G2 grating
214 grating drive unit
22 radiation source
23 detection unit
3 angle changing unit
4 processing unit
41 characteristic acquisition unit
42 data generating unit
5 control unit
6 output unit

What is claimed is:

1. A method of evaluating anisotropy of an object with a phase-contrast X-ray optical system for detecting scattering of X-rays due to the object, the object having an anisotropic structure oriented in at least one direction, the method comprising:
a step of irradiating the object with the X-rays from a radiation source of the phase-contrast X-ray optical system;
a step of acquiring a change characteristic in X-ray scattering intensities for individual relative angles each formed between an incident angle of the X-rays and the anisotropic structure in the object; and
a step of generating evaluation data for evaluating a state of the anisotropic structure in the object based on the change characteristic in the X-ray scattering intensities.

2. The method of evaluating anisotropy according to claim 1, wherein
the change characteristic is any one of a peak intensity obtained through fitting of a change in the X-ray scattering intensities with a predetermined function, a peak angle that is the relative angle at the peak intensity, and a peak width.

3. The method of evaluating anisotropy according to claim 1, wherein
the change characteristic is any one of a peak intensity obtained through fitting of a change in the X-ray scattering intensities with a predetermined function, a peak angle that is the relative angle at the peak intensity, and a peak width, and
the evaluation data is an image in which: one of the peak intensity, the peak angle, and the peak width is represented by one of brightness and color; and another one is represented by another of brightness and color.

4. The method of evaluating anisotropy according to claim 1, wherein
the step of acquiring the change characteristic in the X-ray scattering intensities for individual relative angles each formed between an incident angle of the X-rays and the anisotropic structure in the object is performed while at least one grating that constitutes the phase-contrast X-ray optical system is moved in a periodic direction.

5. An anisotropy evaluation apparatus, comprising:
a phase-contrast X-ray optical system configured to detect scattering of X-rays due to an object;
an angle changing unit configured to change a relative angle between the object and the X-rays; and
a processing unit, wherein
the phase-contrast X-ray optical system includes:
a grating unit;
a radiation source configured to irradiate the grating unit and the object with X-rays; and
a detection unit configured to detect the X-rays that have passed through the grating unit and the object,
the object has an anisotropic structure oriented in at least one direction,
the angle changing unit is configured to change a relative angle between an incident angle of the X-rays and the anisotropic structure in the object, and
the processing unit includes:
a characteristic acquisition unit configured to acquire a change characteristic in X-ray scattering intensities for individual relative angles each formed between the X-rays and the object, using intensity values of the X-rays detected by the detection unit; and
a data generating unit configured to generate evaluation data for evaluating a state of the anisotropic structure in the object based on the change characteristic in the X-ray scattering intensities.

6. The anisotropy evaluation apparatus according to claim 5, wherein
the angle changing unit is configured to rotate the object, and a rotation axis of the object is orthogonal to an incident direction of the X-rays.

7. The anisotropy evaluation apparatus according to claim 5, wherein
an irradiation direction of the X-rays is radial, and
the angle changing unit is configured to change a relative angle between an incident angle of the X-rays and the object by linearly moving the object in a direction intersecting with the irradiation direction of the X-rays.
